(19) United States
(12) Patent Application Publication
(10) Pub. No.: US 2026/0227903 A1
(43) Pub. Date: Aug. 6, 2026

(54) METHOD FOR LOGICAL STORAGE MANAGEMENT FOR INTEGRATED MANAGEMENT OF HETEROGENEOUS STORAGE IN A MACHINE LEARNING ENVIRONMENT AND MACHINE LEARNING SYSTEM THEREFOR

(71) Applicant: Vessl Al Korea Inc., Gwangju (KR)

(72) Inventors: Gi Sung PARK, Yongin-si (KR); Seung Won SHIN, Seoul (KR); Jae Young KANG, Goyang-si (KR)

(73) Assignee: Vessl Al Korea Inc., Gwangju (KR)

(21) Appl. No.: 19/302,320

(22) Filed: Aug. 18, 2025

(30) Foreign Application Priority Data
Jan. 31, 2025 (KR) 10-2025-0012164

(51) Int. Cl. G06F 3/06; G06N 20/00

(52) U.S. Cl. CPC G06F 3/0604; G06F 3/0665; G06F 3/0683; G06N 20/00

(57) ABSTRACT

Disclosed is a logical storage management method for heterogeneous storage integrated management in a machine learning environment, which is performed by a machine learning operations system including an agent and a machine learning operations platform. The method includes creating, by the agent, logical storage for a user, which is capable of being managed by integrating a plurality of heterogeneous storage, in response to a storage registration command from the user, setting up, by the agent, a logical volume by generating the logical volume and volume metadata for the logical storage based on the logical storage in response to a volume generation command from the user, and performing, by the machine learning operations platform, a machine learning task by mounting or importing volume data of target storage corresponding to a volume of the logical storage in response to a machine learning task request from the user.

### CROSS-REFERENCE TO RELATED APPLICATIONS

This application claims priority under 35 U.S.C. § 119 to Korean Patent Application No. 10-2025-0012164 filed on Jan. 31, 2025, in the Korean Intellectual Property Office, the disclosures of which are incorporated by reference herein in their entireties.

### BACKGROUND

Embodiments of the present disclosure described herein relate to a logical storage management method for integrally managing heterogeneous storage applicable to a machine learning environment and a machine learning operations system therefor, and more particularly, relate to a technology for integrally supporting cloud storage and on-premise storage, allowing a user to download data quickly and stably from various kinds of external storage, and storing and reusing data systematically through a volume which is dynamically generated and managed.

With the development of machine learning (ML) and artificial intelligence (AI) technologies, solutions using the ML and AI technologies are being actively developed in various industries. The importance of a machine learning operations (MLOps) platform is increasing to efficiently manage the development, distribution, and operations of ML/AI models.

The MLOps platform provides an integrated environment which manages the entire lifecycle of the ML/AI models, including data preparation, model training, evaluation, deployment, monitoring, etc. This allows data scientists and ML engineers to focus on model development, and companies may improve the productivity and quality of ML/AI projects.

A conventional MLOps platform is mainly established in the form of a service which is provided in a cloud environment. The conventional MLOps platform thus established is advantageous in terms of scalability and flexibility but is disadvantageous in terms of data security, regulatory compliance, and network bandwidth. Accordingly, there is an increasing demand for establishing the MLOps platform in an on-premise environment.

Meanwhile, as a workload requiring large-scale data processing such as machine learning and deep learning spreads, the Kubernetes which is a container-based orchestration platform is being utilized in various environments. For ML model training and inference in the environments, there is a need to efficiently load and manage a large dataset, a model parameter, and a pre-training model weight.

Conventionally, a variety of storage such as cloud storage and on-premise storage-based local disk should be implemented individually and should be managed at the back end. In this case, there is an issue that different access mechanisms, authentication manners, and interfaces should be built and used for respective environments.

The complexity of the conventional manner hinders the portability and scalability of ML workloads and causes the inefficiency in processes of building and managing a learning data pipeline, retraining a model, and storing a resultant output.

Accordingly, there is an increasing need for a technology for integrating a variety of storage with one interface and efficiently managing a distributed storage capable of supporting processing such as data loading, mounting, and exporting in the Kubernetes environment.

The present disclosure is directed to provide a logical storage management technology for heterogeneous storage integrated management in a machine learning environment.

A conventional storage management manner has limitations in that the integration of heterogeneous storage is impossible. That is, there is a limitation in that it is impossible to manage different cloud storage and on-premise storage with one integrated interface.

Also, the conventional storage management manner is inefficient in data management. In other words, there is a lack of a consistent management layer for moving, synchronizing, and accessing data of different locations, which makes data management between cloud and on-premise or a plurality of storage cumbersome.

In addition, in the conventional storage management manner, resource management is restrictive. That is, a mechanism for efficiently managing a plurality of independent volumes in single storage and dynamically allocating and retrieving the volumes to and from workloads is restrictive.

Furthermore, the conventional storage management manner is difficult to meet specific requirements of ML workloads. That is, the conventional storage management manner is difficult to meet requirements specialized for ML workload, such as model retraining, pre-training data loading, and large-scale parameter file access.

Accordingly, the inventor(s) of the present disclosure provides a logical storage technology capable of solving the above limitations or difficulties and effectively providing integrated management of heterogeneous storage in a machine learning environment.

An embodiment of the present disclosure is directed to provide an integrated interface for managing the heterogeneous storage such that APIs for various types of storage such as AWS S3, GCS, NFS, and a local disk are abstracted into a single interface, which provides easy storage interworking and management to the user.

An embodiment of the present disclosure is directed to provide a one-to-many relationship volume management function such that an architecture capable of easily generating a plurality of volumes during interworking with one storage is provided, which enables management and reuse of data at detailed unit.

An embodiment of the present disclosure is directed to provide cloud and on-premise interworking optimization such that there is provided the portability to seamlessly import and export data required to execute a workload in a cluster in both cloud and on-premise environments.

An embodiment of the present disclosure is directed to provide efficiency specialized for an ML workload, and to simplify an ML workflow by supporting automatic data loading and automatic save and export of learning results through Python SDK, CLI, and YAML settings in the process of driving a workload container such that a processing speed is improved.

Problems to be solved by the present disclosure are not limited to the above problems, and other problems not mentioned herein may be clearly understood from the specification and the accompanying drawings by one skilled in the art to which the present disclosure pertains.

### SUMMARY

According to an embodiment, a logical storage management method for heterogeneous storage integrated management in a machine learning environment, which is performed by a machine learning operations system including an agent and a machine learning operations platform includes creating, by the agent, logical storage for a user, which is capable of being managed by integrating a plurality of heterogeneous storage, in response to a storage registration command from the user, setting up, by the agent, a logical volume by generating the logical volume and volume metadata for the logical storage based on the logical storage in response to a volume generation command from the user, and performing, by the machine learning operations platform, a machine learning task by mounting or importing volume data of target storage corresponding to a volume of the logical storage in response to a machine learning task request from the user.

According to an aspect of the present disclosure, the method may further include exporting the corresponding volume data to the target storage, when the machine learning task on the imported volume data is completed.

According to another aspect of the present disclosure, the creating of the logical storage for the user may include generating, by the agent, a storage registration request in response to the storage registration command from the user, the storage registration request including storage information and authentication information about the plurality of heterogeneous storage, performing, by the machine learning operations platform, accessibility verification on the storage registration request, and setting storage interworking by generating storage registration information about the user based on a result of the accessibility verification, the storage registration information including storage metadata and authentication information about the plurality of heterogeneous storage.

According to another aspect of the present disclosure, the setting up of the logical volume may include generating, by the agent, a volume generation request in response to the volume generation command from the user, the volume generation request including logical storage information and volume information, and setting up, by the machine learning operations platform, the logical volume by recording metadata about the volume generation request in a database.

According to another aspect of the present disclosure, the performing of the machine learning task by mounting or importing the volume data of the target storage corresponding to the volume of the logical storage may include generating, by the agent, a machine learning task definition specification in response to the machine learning task request from the user, checking, by the machine learning operations platform, a task volume belonging to the logical storage depending on the machine learning task definition specification and mounting or importing volume data of target storage corresponding to the task volume, and performing, by the machine learning operations platform, machine learning on the mounted or imported volume data.

According to another aspect of the present disclosure, the generating of the machine learning task definition specification in response to the machine learning task request from the user may include specifying, by the agent, the task volume in the logical storage from the machine learning task request from the user, setting, by the agent, a path and an allocation method for allocating the task volume, and generating, by the machine learning operations platform, the machine learning task definition specification including the task volume, the allocation method, and the path.

According to another aspect of the present disclosure, the machine learning operations system includes a database that stores the storage metadata and storage authentication information, metadata associated with a volume generation request, and metadata associated with the machine learning task definition specification.

According to an embodiment, a machine learning operations system includes a machine learning operations platform that performs machine learning depending on a job specification associated with a machine learning task request, when the machine learning task request is received from a user, and a logical storage agent that integrates and manages a plurality of heterogeneous storage. The logical storage agent creates logical storage for the user, which is capable of being managed by integrating the plurality of heterogeneous storage, in response to a storage registration command from the user, and sets up a logical volume by generating the logical volume and volume metadata for the logical storage based on the logical storage in response to a volume generation command from the user. The machine learning operations platform performs a machine learning task by mounting or importing volume data of target storage corresponding to a volume of the logical storage in response to the machine learning task request from the user.

According to an embodiment, a non-transitory computer-readable recording medium may be coupled to a computer, which is hardware, and may include instructions causing the computer to execute the machine learning operation method in the private network described above.

Technical solutions of the present disclosure are not limited to the above solutions, and solutions which are not mentioned will be clearly understood by one skilled in the art to which the present disclosure pertains from the specification and the accompanying drawings.

### BRIEF DESCRIPTION OF THE FIGURES

The above and other objects, features and advantages of the present disclosure will become more apparent to those of ordinary skill in the art by describing exemplary embodiments thereof in detail with reference to the accompanying drawings.

FIG. 1 is a block configuration diagram illustrating a configuration of a machine learning operations system, according to an embodiment of the present disclosure.

FIG. 2 is a conceptual diagram illustrating an architecture of a machine learning operations system, according to an embodiment of the present disclosure.

FIG. 3 is a block diagram illustrating a configuration of a computing device for machine learning operations, according to an embodiment of the present disclosure.

FIG. 4 is a sequence diagram illustrating a user compute cluster authentication process using a unique one-time token, according to an embodiment of the present disclosure.

FIG. 5 is a sequence diagram illustrating a process in which a task execution command of a user is scheduled to a compute cluster, according to an embodiment of the present disclosure.

FIG. 6 is a sequence diagram illustrating a monitoring data collection process and a process in which monitoring data are transmitted to a machine learning operations platform, according to an embodiment of the present disclosure.

FIG. 7 is a flowchart describing a method for machine learning operations in a private network environment, according to an embodiment of the present disclosure.

FIG. 8 is a flowchart describing a logical storage management method for heterogeneous storage integrated management in a machine learning environment, according to an embodiment of the present disclosure.

FIGS. 9 and 10 are conceptual diagrams describing examples a logical storage management method for heterogeneous storage integrated management in a machine learning environment, according to an embodiment of the present disclosure.

FIG. 11 is a sequence diagram illustrating a storage registration and volume generation process for heterogeneous storage integrated management, according to an embodiment of the present disclosure.

FIG. 12 is a sequence diagram illustrating a volume import process and a volume mount process which are performed based on logical storage when a machine learning task is performed by using integrated logical storage, according to an embodiment of the present disclosure.

FIG. 13 is a sequence diagram illustrating a volume export process which is performed based on logical storage when a machine learning task is performed by using integrated logical storage, according to an embodiment of the present disclosure.

FIG. 14 is a flowchart describing a balancing allocation method in a logical storage management method for heterogeneous storage integrated management in a machine learning environment, according to an embodiment of the present disclosure.

FIG. 15 is a flowchart describing a method of dynamically reallocating workload-specific storage, according to an embodiment of the present disclosure.

FIG. 16 is a flowchart describing a volume automatic-partition and merging providing method, according to an embodiment of the present disclosure.

FIG. 17 is a flowchart describing a storage availability prediction and pre-allocation method, according to an embodiment of the present disclosure.

FIG. 18 is a flowchart describing a storage-based data lifecycle management method, according to an embodiment of the present disclosure.

FIG. 19 is a flowchart describing a method of providing a user-customized storage policy, according to an embodiment of the present disclosure.

### DETAILED DESCRIPTION

Specific structural or functional descriptions which are described in the specification in association with various embodiments according to the present disclosure are provided only for the purpose of describing embodiments according to the present disclosure, and the embodiments according to the present disclosure may be carried out in various different forms, not limiting the embodiments described in the specification.

Because the embodiments according to the present disclosure are susceptible to various modifications and alternative forms, the embodiments will be shown as an example in the drawings and will be described in detail in the specification. However, the embodiments according to the present disclosure include modifications, equivalents, and alternatives falling within the spirit and scope of the present disclosure, not limiting the embodiments according to the present disclosure to particular forms disclosed herein.

Even though the terms “first”, “second”, etc. may be used to describe various components, the components should not be construed as being limited by the terms. These terms are only used to distinguish one element from another. For example, a first element may be termed a second element, and, similarly, the second element may be termed the first element, without departing from the scope of the present disclosure.

It should be understood that when a first component is referred to as being “connected” or “coupled” to a second component, the first component may be directly connected or coupled to the second component or intervening components may be present therebetween. In contrast, when a component is referred to as being “directly connected” or “directly coupled” to another component, it should be understood that any other component is not interposed therebetween. Expressions used to describe relationships between components, for example, “between” versus “directly between”, “adjacent” versus “directly adjacent,” etc. should be interpreted in a like fashion.

The terms used herein are only to describe specific embodiments and are not intended to limit the present disclosure. The articles “a”, “an”, and “the” are singular in that they have a single referent, but the use of the singular form should not preclude the presence of more than one referent. In the specification, it should be understood that the terms “comprises”, “comprising”, “includes”, “including”, etc. specify that described features, numbers, steps, operations, components, or parts or a combination thereof exists, but do not preclude the presence or addition of one or more other features, numbers, steps, operations, components, or parts or a combination thereof.

Unless otherwise defined, all terms including technical and scientific terms used herein have the same meaning as commonly understood by one of ordinary skill in the art to which the present disclosure pertains. It will be further understood that terms defined in commonly used dictionaries should be interpreted as having a meaning consistent with their meaning in the context of the related art and will not be interpreted in an idealized or overly formal sense unless expressly so defined herein.

In the specification, a processor may refer to hardware capable of performing a function and an operation according to each name described in the specification, may refer to a computer program code capable of performing a specific function and a specific operation, or may refer to an electronic recording medium equipped with a computer program code capable of performing a specific function and a specific operation.

In other words, the processor may refer to a functional and/or structural combination of hardware for carrying out the technical idea of the present disclosure and/or software for driving the hardware.

Below, embodiments will be described in detail with reference to the accompanying drawings. However, the scope of the patent application is neither limited nor restricted by the embodiments. The same reference numerals/signs in the drawings denote the same members.

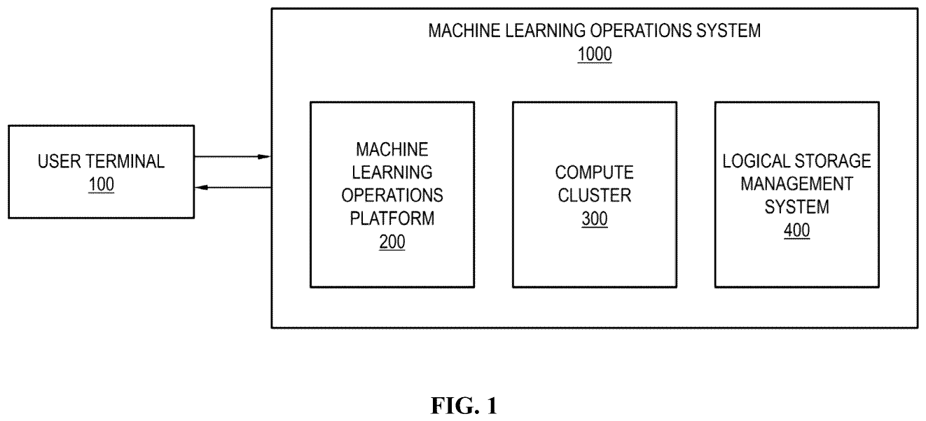

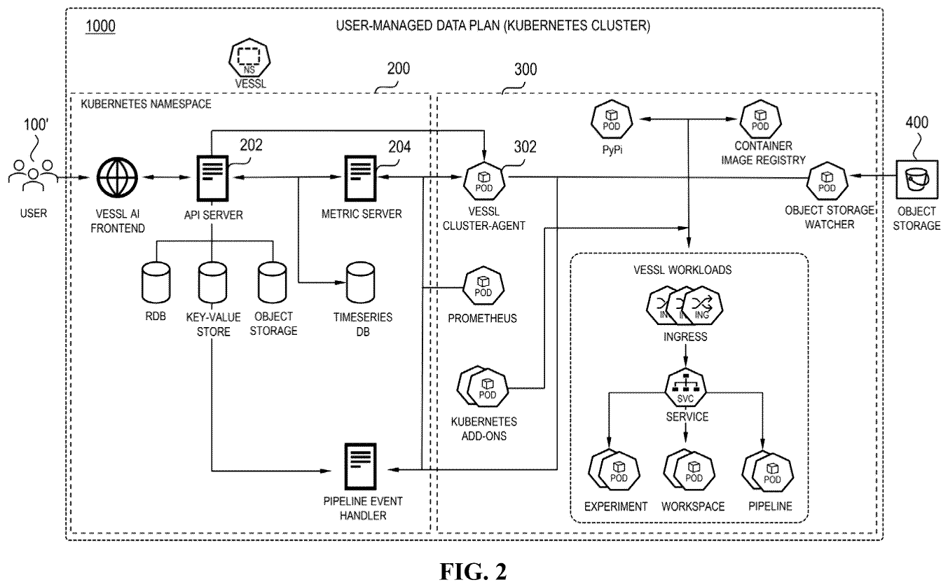

FIG. 1 is a block configuration diagram describing a configuration of a machine learning operations system, according to an embodiment of the present disclosure, and FIG. 2 is a conceptual diagram illustrating an architecture of a machine learning operations system, according to an embodiment of the present disclosure.

Referring to FIGS. 1 and 2, a machine learning operations system 1000 according to an embodiment of the present disclosure interworks with a user terminal 100. The user 100′ may connect to the machine learning operations system 1000 through the user terminal 100 and may user machine learning operations and logical storage operations functions which the machine learning operations system 1000 provides.

The machine learning operations system 1000 may include a machine learning operations platform 200 corresponding to a control plane, a compute cluster 300 corresponding to a data plane capable of being operated on the infrastructure of the user terminal 100, and a logical storage management system 400 which logically integrates and manages a variety of storage present inside/outside the machine learning operations system 1000.

According to an embodiment of the present disclosure, the machine learning operations platform 200 may be a machine learning operations (MLOps) platform or a large language model operations (LLMOps) platform or may be implemented as a partial function of the platform. According to an embodiment, the machine learning operations system 1000 and/or the machine learning operations platform 200 is capable of being implemented as a machine learning operations (MLOps) environment or a large language model operations (LLMOps) environment. Alternatively, the machine learning operations system 1000 and/or the machine learning operations platform 200 is also capable of being applied to various application environments or platforms based on a machine learning operations (MLOps) environment or a large language model operations (LLMOps) environment.

The machine learning operations platform 200 which is a platform for automating and managing the entire lifecycle including development, deployment and operations of a machine learning model and may directly provide core functions of machine learning, services, and computational resource allocation to the user terminal 100. The machine learning operations platform 200 may perform functions such as user authentication, machine learning task scheduling, machine learning model version management, and experiment tracking. In an embodiment, the machine learning operations platform 200 may communicate with the user terminal 100 and the compute cluster 300 through a RESTful API (Representational State Transfer Application Programming Interface, REST API).

The machine learning operations platform 200 may include an API server 202. The API server 202 may execute business logic of the machine learning operations platform 200. The API server 202 may provide an interface which directly communicates with the user terminal 100 by using a method such as a world wide web (Web), a command line interface (CLI), and/or a software development kit (SDK). In addition to the API server 202, the machine learning operations platform 200 may further include a metric server 204 which stores and queries logs, metrics, and/or files generated from workloads, a database, etc.

In an embodiment of the present disclosure, the computational resource may be established in the form of a cluster. According to an embodiment of the present disclosure, the compute cluster 300 may be a component which the user terminal 100 holds and is established in the private network environment. The computational resource includes hardware resources, which are necessary at respective stages of the machine learning lifecycle, such as a central processing unit (CPU), a graphic processing unit (GPU), a memory, and a storage may be implemented in the compute cluster 300. The compute cluster 300 may execute the actual ML/AI workload. According to an embodiment, the compute cluster 300 may be implemented based on a container and may be managed by using the Kubernetes.

The compute cluster 300 may include a cluster agent 302. The compute cluster 300 may communicate with the machine learning operations platform 200 through the cluster agent 302.

As a key component installed in the compute cluster 300, the cluster agent 302 is a subject which manages the compute cluster 300. The cluster agent 302 may serve to communicate with the machine learning operations platform 200. The cluster agent 302 may perform functions such as machine learning task execution, status report, and computational resource monitoring. In detail, the cluster agent 302 may control and determine how to execute a machine learning task which the user requests, how to report the status of machine learning tasks in the compute cluster 300 to the user terminal 100, how to monitor an allocation present situation of the computational resource for the machine learning task, etc. According to an embodiment of the present disclosure, because most of the data necessary for machine learning includes sensitive information which should not be exposed to the outside, the compute cluster 300 is in a state of being set to use only the outbound connection. In other words, the compute cluster 300 according to an embodiment of the present disclosure may be implemented with a network in which the outbound traffic is permitted and the inbound traffic is not permitted. According to the above description, the security of the machine learning operations system 1000 according to an embodiment of the present disclosure may be reinforced. Due to the above characteristic of the compute cluster 300, the user terminal 100 communicates only through the machine learning operations platform 200, and the cluster agent 302 operates to schedule and control the machine learning task to the computational resource in the compute cluster 300 depending on a request of the user.

The logical storage management system 400 may logically integrate a variety of storage and may manage the variety of storage through one integrated interface.

The logical storage management system 400 may inherently process various access mechanisms and various authentication manners of not only cloud storage such as AWS S3 and GCS but also on-premise storage such as NFS and HostPath-based local disk, and thus, the user may conveniently use a variety of dispersed storage as one storage.

The logical storage management system 400 may abstract APIs for various types of storage such as AWS S3 (Amazon Simple Storage Service), GCS (Google Cloud Storage), NFS (Network File System), and local disk into a single integrated interface, which provides easy storage interworking and management to the user.

The logical storage management system 400 may provide a one-to-many relationship volume management function. That is, an architecture capable of easily generating a plurality of volumes during interworking with one storage may be provided, which enables management and reuse of data at detailed file unit.

The logical storage management system 400 may provide the portability to seamlessly import and export data required to execute a workload in a cluster in both cloud and on-premise environments, and thus, cloud and on-premise interworking may be optimized.

The logical storage management system 400 may support automatic data loading and automatic save or export of learning results through Python SDK, CLI, and YAML settings in the process of driving a workload container, thus simplifying an ML workflow and improving a processing speed.

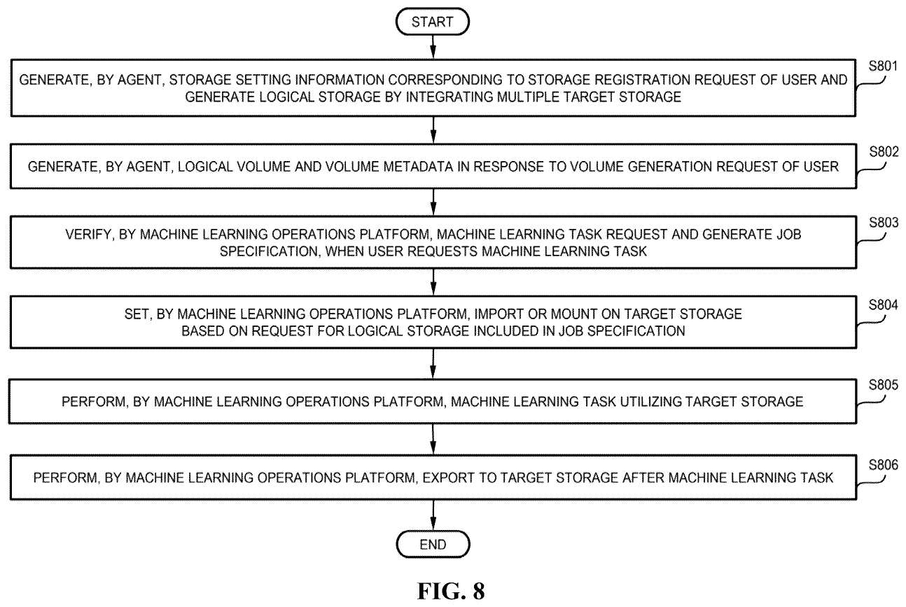

Below, the logical storage management system 400 will be described with reference to FIGS. 8 to 11.

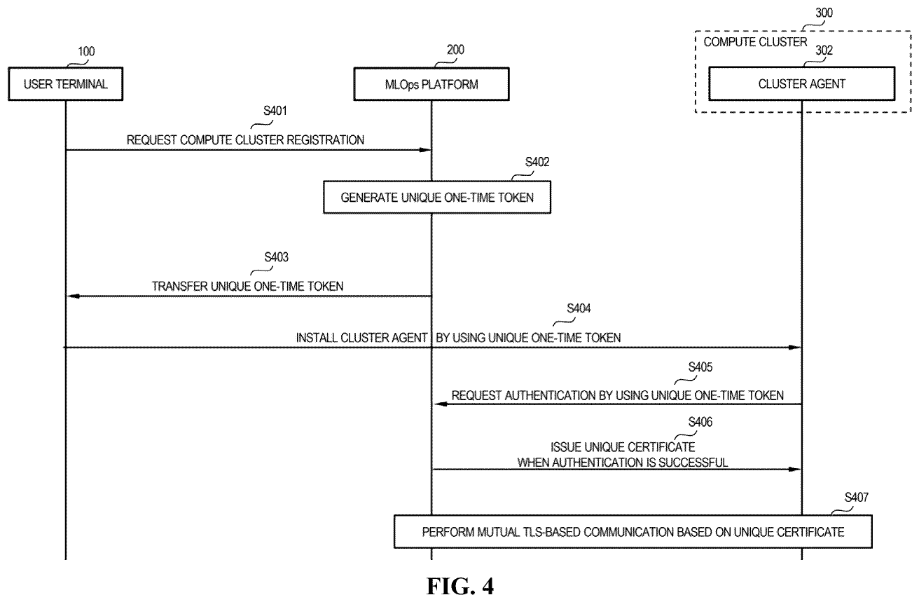

The security mechanism of the machine learning operations system 1000 according to an embodiment of the present disclosure may be implemented by encrypting all communications in the machine learning operations system 1000 through the HTTPS (Hypertext Transfer Protocol Secure), using mutual transport layer security (mTLS) communication, and verifying the validity of each request by using a token-based authentication system. This will be described with reference to FIG. 4.

The security mechanism of the machine learning operations system 1000 according to an embodiment of the present disclosure may be implemented by allowing the cluster agent 302 to periodically perform polling on the machine learning operations platform 200 to check a new machine learning task or a command from the user 100.

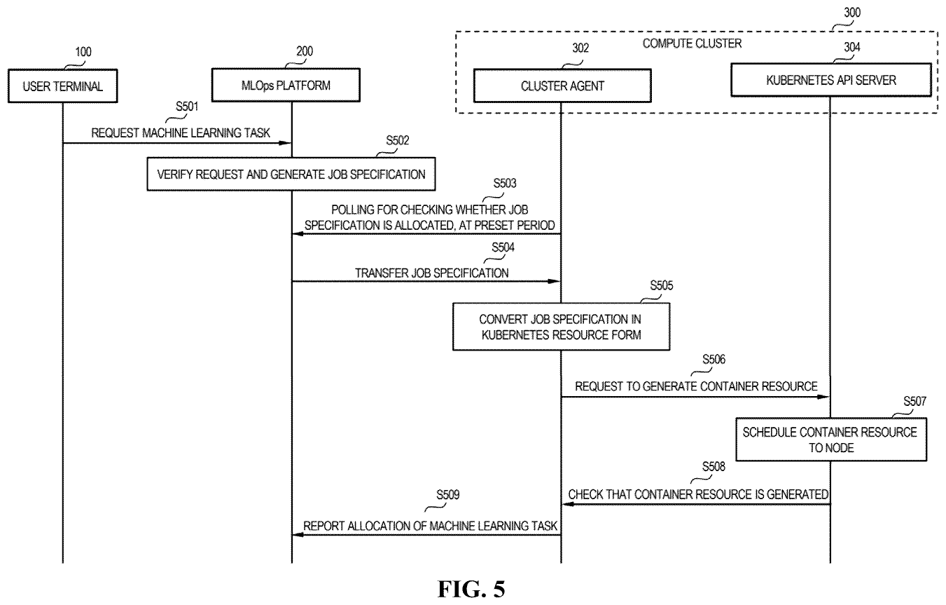

In detail, because the compute cluster 300 according to an embodiment of the present disclosure uses only the outbound connection from the internal network to the outside, it is impossible for the machine learning operations platform 200 to instruct the machine learning task directly to the compute cluster 300. In this case, according to an embodiment of the present disclosure, to perform the machine learning task with the computational resource which the user terminal 100 holds, the cluster agent 302 included in the compute cluster 300 may perform polling on the machine learning operations platform 200 based on a preset period and may determine whether a job specification for the machine learning task is allocated. This will be described with reference to FIG. 5.

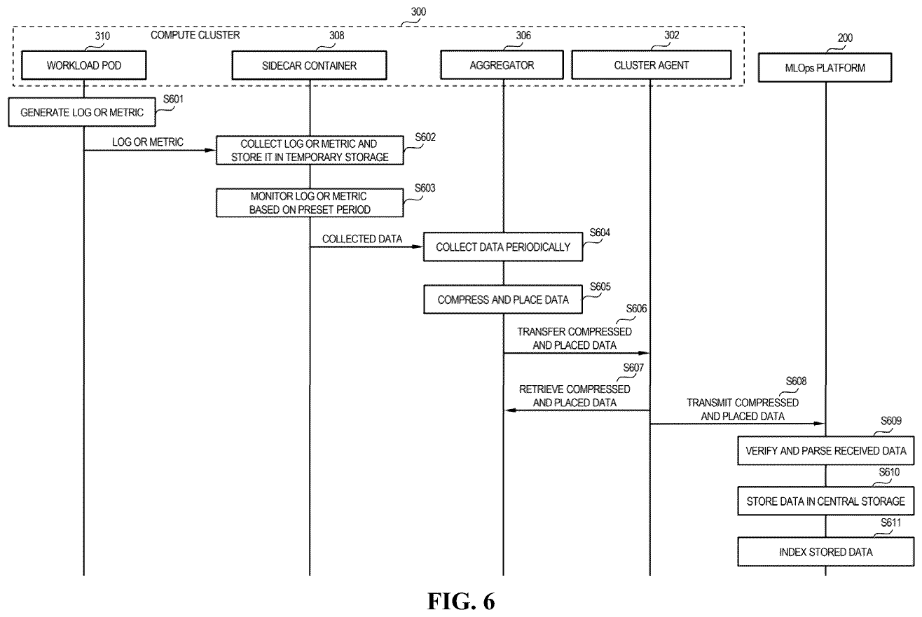

The machine learning operations system 1000 according to an embodiment of the present disclosure may dynamically allocate and monitor the computational resource. In detail, a resource manager which is installed at each node of the compute cluster 300 may monitor, in real time, usage amounts of resources such as a CPU, a memory, and a GPU. Monitoring data (e.g., logs and/or metrics) collected in the compute cluster 300 may be stored in real time through a Prometheus component and may be periodically reported to the machine learning operations platform 200. A scheduler of the machine learning operations platform 200 may perform optimal resource allocation determination, based on the monitoring data periodically reported to the machine learning operations platform 200. A sidecar container may be together distributed to each workload and may collect monitoring data including logs or metrics. After the collected monitoring data are buffered in a local temporary storage, the collected monitoring data may be compressed or placed in an aggregator so as to be transmitted to the machine learning operations platform 200. This will be described with reference to FIG. 6.

For data security and regulatory compliance, the machine learning operations system 1000 according to an embodiment of the present disclosure may support the flexible establishment of a machine learning operations platform at the cloud level even in an on-premise environment. According to the above description, the machine learning operations system 1000 according to an embodiment of the present disclosure may improve container-based ML/AI project productivity and quality through efficient allocation and monitoring of a special hardware resource such as a GPU. Also, the machine learning operations system 1000 according to an embodiment of the present disclosure may reinforce security through auto-generated one-time tokens and mutual TLS authentication and may overcome restrictions on network security policies by using only the outbound connection. In addition, the machine learning operations system 1000 according to an embodiment of the present disclosure may optimize machine learning costs through a real-time resource monitoring and dynamic allocation system in the container environment. Furthermore, the machine learning operations system 1000 according to an embodiment of the present disclosure may effectively collect various indicators and logs by utilizing the cluster agent and the sidecar container and may provide the collected indicators and logs to the user, and thus, performance or indicator monitoring and maintenance of the machine learning model may become easier.

The machine learning operations system 1000 according to an embodiment of the present disclosure may automate and optimize a data access required for an ML workload while integrally managing various types of storage backends with a single interface. To this end, the machine learning operations system 1000 may integrate a plurality of external storage (AWS S3, GCS, NFS, local disk, etc.) with a single interface to register and set up logical storage; in this case, it may be possible to provide a space accessible through a POSIX (Portable Operating System Interface) file system interface inside the ML workload container such that a volume for the logical storage is registered and set up. The volume may provide an import function to fetch a file from target storage, an export function to again apply changes to the target storage after use completion, and/or a mount function to mount a specific directory to a volume during execution. The volume with the specific directory mounted can be utilized like a local volume.

The machine learning operations system 1000 according to an embodiment of the present disclosure disclosed in FIGS. 1 and 2 is described under the condition that the compute cluster 300 and the logical storage management system 400 are independent of each other, and this is provided for convenience of description. For example, the compute cluster 300 and the logical storage management system 400 may be implemented such that at least some function are shared or are integrated as one function element.

For example, the logical storage management system 400 may include a logical storage agent for logical storage setup and allocation, and the logical storage agent may be integrally implemented with a cluster agent of a compute cluster. That is, in the present disclosure, each component is functionally classified and described for convenience of description. According to an embodiment, it is possible to integrate components or to use some functions in common.

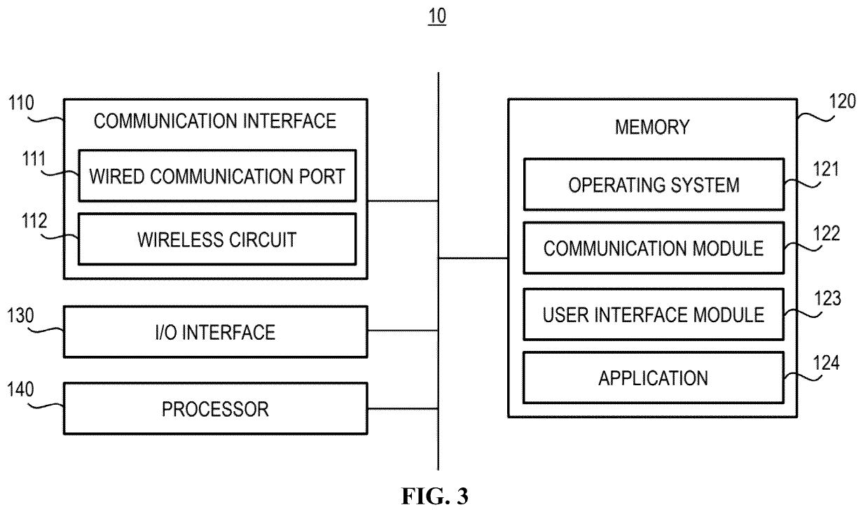

FIG. 3 is a block diagram illustrating a configuration of a computing device for machine learning operations, according to an embodiment of the present disclosure.

Referring to FIG. 3, a computing device 10 for machine learning operations may be a server which provides a machine learning operations service depending on a request of a user (or a user device) or a user device in which a web page, an application, and/or a program capable of performing machine learning operations is installed and executed.

The computing device 10 for machine learning operations may include a communication interface 110, a memory 120, an I/O interface 130, and/or a processor 140, which communicate with each other through one or more communication buses or signal lines.

The communication interface 110 may connect to a user device (not illustrated) over a wired/wireless communication network to exchange data. For example, when the computing device 10 for machine learning operations is a server, the communication interface 110 may receive a machine learning task command or a compute cluster registration request from the user device. Also, the communication interface 110 may transmit monitoring data including logs and/or metrics to the user. The monitoring data which are transmitted to the user may be data obtained by performing “compressing and placing” and indexing on logs and/or metrics.

Meanwhile, the communication interface 110 which enables the transmission/reception of data may include a wired communication port 111 and a wireless circuit 112. Herein, the wired communication port 111 may include one or more wired interfaces, for example, Ethernet, universal serial bus (USB), IEEE1394 (e.g., FireWire, Apple: i.Link, Sonny: Lynx, Texas Instrument), etc. Also, the wireless circuit 112 may transmit/receive data to/from an external device through a radio frequency (RF) signal or an optical signal. Furthermore, the wireless communication may use at least one of a plurality of communication standards, protocols, and technologies, for example, global system for mobile communications (GSM), enhanced data rates for GSM evolution (EDGE), code-division multiple access (CDMA), time division multiple access (TDMA), Bluetooth, Wi-Fi, VoIP, Wi-MAX, or any other appropriate communication protocol.

The memory 120 may store a variety of data which are used in the computing device 10 for machine learning operations. For example, the memory 120 may store logs, metrics, system metrics, and/or metadata of files, which are generated from workloads. For another example, the memory 120 may store data which the cluster agent 302 collects in the compute cluster 300 according to an embodiment of the present disclosure. Also, the memory 120 may store a collection code directly written by the user or data stored in an automatic upload directory.

In various embodiments, the memory 120 may include a volatile or nonvolatile recording medium capable of storing various kinds of data, commands, and/or information. For example, the memory 120 may include a storage medium of at least one type among the following types: a flash memory type, a hard disk type, a multimedia card micro type, a card type memory (e.g., an SD or XD memory), a random access memory (RAM), a static RAM (SRAM), a read-only memory (ROM), a programmable ROM (PROM), an electrically erasable programmable ROM (EEPROM), network storage, cloud, and a blockchain database.

In various embodiments, the memory 120 may store at least one of an operating system 121, a communication module 122, a user interface module 123, and one or more applications 124.

The operating system 121 (e.g., an embedded operating system such as LINUX, UNIX, MAC OS, WINDOWS, or VxWorks) may include various software components and drivers for controlling and managing general system jobs (e.g., memory management, storage device control, and power management) and may support communication between various hardware, firmware, and software components.

The communication module 122 may support communication with any other device through the communication interface 110. The communication module 122 may include various software components for processing data received by the wired communication port 111 or the wireless circuit 112 of the communication interface 110.

The user interface module 123 may receive a request or an input of the user from a keyboard, a touchscreen, a keyboard, a mouse, and/or a microphone through the I/O interface 130 and may provide a user interface on a display.

The application 124 may include a program or a module which is configured to be executable by one or more processors 140. Herein, an application which provides a service for processing all stages necessary for machine learning research and development, including machine learning, machine learning model distribution, monitoring, and/or computational resource scheduling, may be implemented on a server farm.

The I/O interface 130 may connect an input/output device (not illustrated) of the computing device 10 for machine learning operations, for example, at least one of a display, a keyboard, a touchscreen, and a microphone with the user interface module 123. The I/O interface 130 may receive a user input (e.g., a voice input, a keyboard input, or a touch input) together with the user interface module 123 and may process a command according to the received input.

The processor 140 may be connected to the communication interface 110, the memory 120, and the I/O interface 130 to control all operations of the computing device 10 for machine learning operations and may perform various commands for machine learning operations through the application and/or the program stored in the memory 120.

The processor 140 may correspond to a computing device such as a central processing unit (CPU) or an application processor (AP). Also, the processor 140 may be implemented in the form of an integrated chip (IC) such as a system on chip (SoC) in which various computing devices are integrated. In addition, the processor 140 may include a module for calculating an artificial neural network model such as a neural processing unit (NPU).

Various embodiments of a machine learning operations method which is performed by the machine learning operations system 1000 will be described with reference to FIGS. 4 to 7.

FIG. 4 is a sequence diagram illustrating a process in which a compute cluster of a user is authenticated by using a unique one-time token, according to an embodiment of the present disclosure.

Referring to FIG. 3, there is illustrated a process in which the user terminal 100 installs the cluster agent 302 on the compute cluster 300 through the MLOps platform 200 and performs authentication and interworking on the compute cluster 300 by using a unique one-time token which the MLOps platform 200 generates. In FIG. 4, the MLOps platform 200 may be an example of a machine learning operations platform 200 of FIG. 1.

For security reasons, the MLOps platform 200 needs to authenticate only the compute cluster 300 issuing an explicit command for a computational resource which the user wants to use. According to an embodiment of the present disclosure, the corresponding compute cluster 300 may be initially authenticated only once depending on the request of the user, and afterwards, the corresponding compute cluster 300 may be determined as an authenticated cluster, and the user may continuously perform communication with the corresponding compute cluster 300 through the MLOps platform 200.

Referring to FIG. 4, the user terminal 100 may request a new compute cluster registration request from the MLOps platform 200 (S401).

In response to the request of the user, the MLOps platform 200 may generate a unique one-time token (S402) and may transfer the generated unique one-time token to the user 100 (S403).

The user terminal 100 may install the cluster agent 302 on the compute cluster 300 of the user terminal 100 by using the received unique one-time token (S404). Herein, the user terminal 100 may access the compute cluster 300 solely at an installation step S404 of the entire service operation to declare that the corresponding compute cluster 300 is a cluster dependent on the MLOps platform 200 and to transfer a relevant token to the corresponding compute cluster 300.

During initial booting, the cluster agent 302 may request authentication of the cluster agent 302 to the MLOps platform 200 by using the unique one-time token which the user terminal 100 transfers (S405).

When the MLOps platform 200 authenticates the cluster agent 302, that is, when the cluster agent 302 succeeds in authentication, the MLOps platform 200 may issue a unique certificate to the cluster agent 302 (S406).

Mutual TLS-based communication can be performed between the MLOps platform 200 and the cluster agent 302 based on the unique certificate.

FIG. 5 is a sequence diagram illustrating a process in which a job execution command of a user is scheduled to a compute cluster, according to an embodiment of the present disclosure.

Referring to FIG. 5, there is illustrated a process in which a job execution command which the user terminal 100 gives through the MLOps platform 200 is scheduled to the compute cluster 300 of the user. In FIG. 5, the MLOps platform 200 may be an example of a machine learning operations platform 200 of FIG. 1.

Referring to FIG. 5, the user 100 may request a machine learning task (e.g., machine learning model training) by using a web user interface (UI) or a command-line interface (CLI) (S501).

The MLOps platform 200 may verify the request received from the user terminal 100 and may generate a job specification according to the request (S502). The generated job specification may be stored in an internal database of the MLOps platform 200.

In this case, the step of verifying the request received from the user terminal 100 may be, for example, a step of checking whether the received request is a request to execute a process that the MLOps platform (200) can schedule, whether a computational resource for performing a corresponding task is sufficient, whether the user terminal 100 requests a task which uses data actually accessible by the compute cluster 300, whether a command which the user terminal 100 intends to execute is error-free, etc. The step of verifying the request received from the user terminal 100 may be a step of performing first verification at the MLOps platform 200 for security. Because the compute cluster 300 is set to use only the outbound connection, it is impossible for the MLOps platform 200 to directly request the machine learning task, which is based on the job specification, from the cluster agent 302. The stored job specification and machine learning task request may be transferred to the compute cluster 300 through subsequent steps including step S503.

To check whether the job specification is allocated, the cluster agent 302 may perform polling on the MLOps platform 200 depending on a preset period (e.g., 15 seconds) (S503). As the cluster agent 302 performs polling periodically, the cluster agent 302 may check if there are any job specification not yet allocated on the MLOps platform 200 exists.

At polling of a specific time point, when a job specification not yet allocated exists, the MLOps platform 200 may transfer the job specification not yet allocated to the cluster agent 302 (S504).

The cluster agent 302 may analyze the transferred job specification and may convert the job specification in a Kubernetes resource form (S505). In other words, under the assumption that the corresponding job specification is a job specification already verified, the cluster agent 302 may convert the job specification in a form (e.g., a container) necessary for Kubernetes corresponding to a tool which manages a cluster. According to the above description, the cluster agent 302 may define, retrieve, and/or translate the job specification such that a Kubernetes API server 304 is capable of executing the command of the user 100 as a container.

The cluster agent 302 may generate a required resource (e.g., a workload pod or a job) through the Kubernetes API server 304.

In this case, the cluster agent 302 may request the Kubernetes API server 304 to generate a container resource (S506).

The Kubernetes API server 304 may schedule the container resource to an appropriate node in the compute cluster 300 (S507). A Kubernetes scheduler may allocate the container resource to the appropriate node in the compute cluster 300. In this case, the container resource may be allocated in the form of a Kubernetes pod. The machine learning job may be packaged to a Docker container and may be executed. A workload (e.g., a learning job, an inference service etc.) specialized for machine learning may be defined and managed by using a custom resource definition (CRD) of the Kubernetes. As an example, a computational resource such as a GPU resource may be managed through an NVIDIA Device Plugin and may be dynamically allocated if necessary.

The Kubernetes API server 304 may determine that the container resource for the cluster agent 302 is generated (S508). For example, the Kubernetes API server 304 may transmit, to the cluster agent 302, an “Ack” message indicating that the container resource is generated.

The cluster agent 302 may report, to the MLOps platform 200, that the machine learning task which the user 100 requests is allocated (S509).

According to an embodiment of the present disclosure, because the user fails to directly transfer the machine learning task command to the compute cluster 300, the user may give the machine learning task command to the compute cluster 300 through an interface such as the MLOps platform 200; in this case, the command which the user gives to the MLOps platform 200 may be transferred to the compute cluster 300 through the above process.

FIG. 6 is a sequence diagram illustrating a monitoring data collection process and a process in which monitoring data are transmitted to a machine learning operations platform, according to an embodiment of the present disclosure.

The compute cluster 300 may include a workload pod 310, a sidecar container 308, an aggregator 306, and the cluster agent 302.

In the specification, monitoring data may include logs (log data) and/or metrics (metric data). The log may include an indicator representing a machine learning process in a graph form, an indicator indicating where the workload is actually allocated or scheduled, a time required for machine learning, a characteristic or a type of output data of machine learning data, etc. The metrics may be indicators (e.g., loss and accuracy) expressed as Scalar over time while machine learning is in progress.

According to an embodiment of the present disclosure, the monitoring data generated at the workload pod 310 are not transmitted to the MLOps platform 200 in real time. That is, according to an embodiment of the present disclosure, in consideration of the burden of the machine learning operations service on the network, the monitoring data generated at the workload pod 310 are collected and stored and are then periodically transmitted to the MLOps platform 200.

Referring to FIG. 6, the workload pod 310 may generate logs or metrics (S601). The workload pod 310 may be a learning process generated by a user's request. The sidecar container 308 for log or metric collection may be distributed to the workload pod 310 together with an application container.

The sidecar container 308 may collect logs or metrics and may store the collected logs or metrics in a local temporary storage (e.g., emptyDir volume) (S602). The logs or metrics stored in the sidecar container 308, that is, the monitoring data, should be finally transmitted to the MLOps platform 200.

The sidecar container 308 may continuously monitor the logs or metrics of the application container based on a preset period (S603).

The aggregator 306 may periodically collect data collected from the sidecar container 308, that is, the monitoring data (S604). The aggregator 306 may be referred to as a “central collector” present in the compute cluster 300.

The aggregator 306 may compress and place the collected monitoring data (S605). The aggregator 306 may collect logs or metrics collected from a plurality of sidecar containers including the sidecar container 308 and may compress the collected logs or metrics in one place. The aggregator 306 may prepare efficient transmission by compressing and placing the collected monitoring data.

The aggregator 306 may transfer the compressed and placed monitoring data to the cluster agent 302 (S606). The aggregator 306 may retrieve the compressed and placed monitoring data (S607).

The cluster agent 302 may transmit the compressed and placed monitoring data to the MLOps platform 200 (S608). In an embodiment, the cluster agent 302 may fetch the compressed and placed monitoring data from the aggregator 306 based on a preset period and may then transmit the compressed and placed monitoring data thus fetched to the MLOps platform 200. In another embodiment, when the size of the compressed and placed monitoring data is larger than or equal to a preset threshold, the cluster agent 302 may fetch the compressed and placed monitoring data from the aggregator 306 and may transmit the compressed and placed monitoring data thus fetched to the MLOps platform 200.

The MLOps platform 200 or a log manager (not illustrated) of the MLOps platform 200 may verify and parse the received monitoring data (S609).

The MLOps platform 200 or the log manager of the MLOps platform 200 may store the verified and parsed monitoring data in a central storage (S610).

The MLOps platform 200 may index the monitoring data stored in the central storage (S611). The MLOps platform 200 may perform indexing on the monitoring data stored in the central storage such that the monitoring data are capable of being quickly retrieved and analyzed.

When communication between the MLOps platform 200 and the compute cluster 300 or communication between the MLOps platform 200 and the cluster agent 302 is impossible (e.g., network disconnection), the cluster agent 302 may prevent data loss through a retry mechanism. In detail, the aggregator 306 may initiate the retry mechanism, and the cluster agent 302 may receive the monitoring data from the aggregator 306.

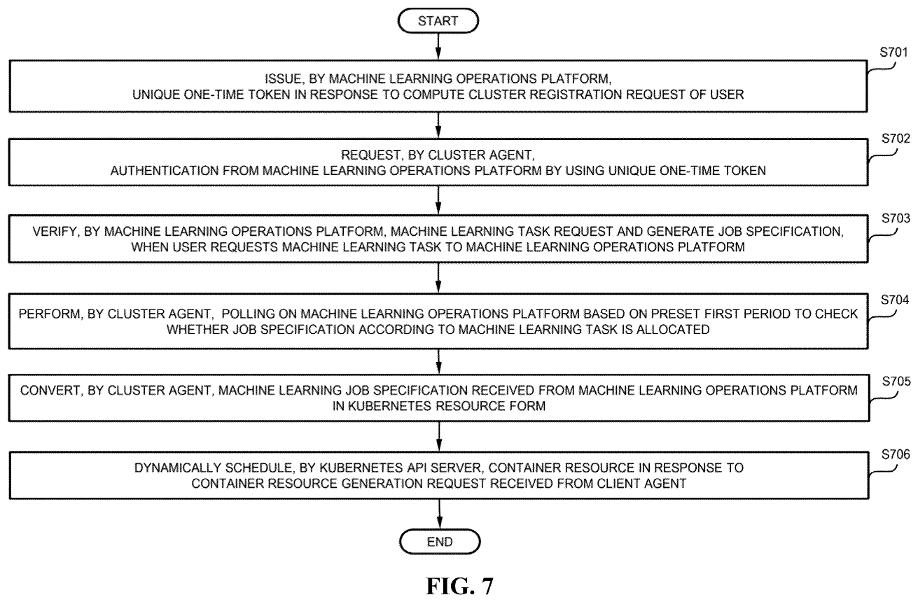

FIG. 7 is a flowchart illustrating a method for machine learning operations in a private network environment, according to an embodiment of the present disclosure.

According to a method for machine learning operations in a private network environment according to an embodiment of the present disclosure, the machine learning operations platform may issue a unique one-time token in response to a compute cluster registration request of a user (S701).

After step S701 where the unique one-time token is issued, the machine learning operations platform may transfer the unique one-time token to the user. Then, the user may install the cluster agent on a compute cluster by using the unique one-time token.

According to the method for machine learning operations in the private network environment according to an embodiment of the present disclosure, the cluster agent may request authentication from the machine learning operations platform by using the unique one-time token (S702).

At step S702 where the authentication using the unique one-time token is requested to the machine learning operations platform, when the authentication is successful, the machine learning operations platform may issue a unique certificate to the cluster agent. Afterwards, the machine learning operations platform and the cluster agent may perform mutual transport layer security (mTLS) communication based on the unique certificate.

According to the method for machine learning operations in the private network environment according to an embodiment of the present disclosure, when the user requests a machine learning task from the machine learning operations platform, the machine learning operations platform may verify the received machine learning task request and may generate a job specification according to the machine learning task request (S703).

According to the method for machine learning operations in the private network environment according to an embodiment of the present disclosure, to check whether a job specification according to the machine learning task request is assigned, the cluster agent may perform polling on the machine learning operations platform based on a preset first period (S704).

According to the method for machine learning operations in the private network environment according to an embodiment of the present disclosure, the cluster agent may convert the job specification received from the machine learning operations platform in a Kubernetes resource form (S705).

According to the method for machine learning operations in the private network environment according to an embodiment of the present disclosure, a Kubernetes API server may dynamically schedule a container resource in response to a container resource generation request received from the cluster agent (S706).

After step S706 where the container resource is dynamically scheduled, the Kubernetes API server may notify the cluster agent that the container resource corresponding to the machine learning job is generated, to the cluster agent. Afterwards, the cluster agent may report that the machine learning task is allocated.

In an embodiment, when monitoring data are generated at a workload pod, a sidecar container may monitor the monitoring data based on a preset second period. Also, the sidecar container may collect the monitoring data and may store the collected monitoring data in a temporary storage. Afterwards, an aggregator may collect the monitoring data collected and stored by the sidecar container from the sidecar container based on a preset third period. Next, the aggregator may compress and place the monitoring data collected by the aggregator.

The machine learning operations platform may receive the compressed and placed monitoring data. In addition, the machine learning operations platform may verify and parse the monitoring data thus compressed and placed. Then, the machine learning operations platform may store the compressed and placed monitoring data in a central storage. Afterwards, the machine learning operations platform may index the monitoring data thus compressed and placed.

The machine learning operations system according to an embodiment may include a machine learning operations platform configured to issue a unique one-time token in response to a compute cluster registration request of the user, to verify a received machine learning task request when the machine learning task request is received from the user, and to generate a job specification according to the machine learning task request, and a compute cluster.

The compute cluster may include a cluster agent configured to request authentication from the machine learning operations platform by using the unique one-time token, to perform polling on the machine learning operations platform based on a preset first period to determine whether the job specification according to the machine learning task request is allocated, and to convert the job specification received from the machine learning operations platform in a Kubernetes resource form, and a Kubernetes API server configured to dynamically schedule a container resource in response to a container resource generation request received from the cluster agent.

The compute cluster may be implemented with a network which permits the outbound traffic and does not permit the inbound traffic.

Below, various embodiments of a logical storage management method for heterogeneous storage integrated management which is performed by the machine learning operations system 1000 will be described with reference to FIGS. 8 to 14.

FIGS. 8 to 14 to be described below are capable of being implemented through the interworking of the machine learning operations platform 200 and a logical storage agent which is an agent of the logical storage management system 400 in the machine learning operations system 1000. Below, an agent means a “logical storage agent” and is described as an agent which implements a function of the logical storage management system 400. According to an embodiment, the logical storage management system 400 is integrated with the compute cluster 300 described with reference to FIGS. 2 to 7 or is capable of being implemented to use some functions in common.

FIG. 8 is a flowchart describing a logical storage management method for heterogeneous storage integrated management in a machine learning environment, according to an embodiment of the present disclosure.

According to a method for machine learning operations in a private network environment according to an embodiment of the present disclosure, an agent may generate logical storage for the user, in which a plurality of different storage, that is, heterogeneous storage, are capable of being integrated and managed, in response to a storage registration command from the user (S801).

The logical storage may be implemented by integrating a plurality of different real storage (the real storage referred to as “target storage”), that is, heterogeneous storage, and the logical storage may be individually generated for each user (or for each user group).

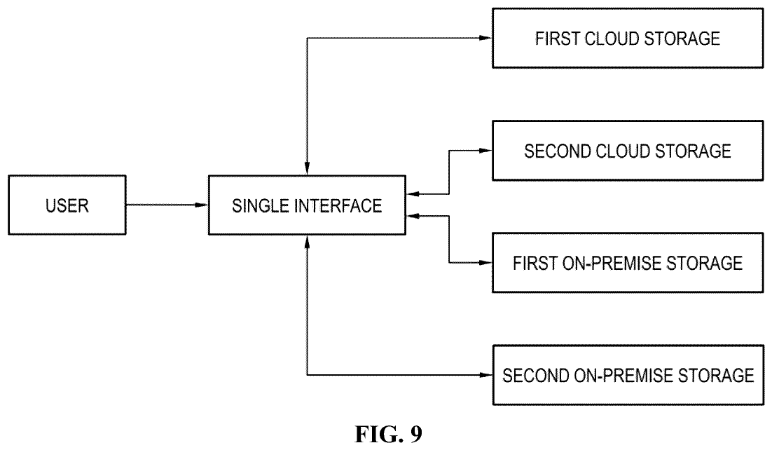

FIG. 9 shows an example of the logical storage. The agent provides a single interface for the integrated logical storage, and the user is capable of using various target storage conveniently while recognizing various target storage as one storage by using the single interface. The integrated interface may abstract APIs for various target storage (e.g., AWS S3, GCS, NFS, and a local disk) to a single interface, which provides easy storage interworking and management to the user. An example in which two cloud storage and two on-premise storage constitute one logical storage is illustrated in FIG. 9, but the present disclosure is not limited thereto.

The agent may generate a logical volume and volume metadata for the logical storage based on the logical storage in response to a volume generation command from the user and may perform logical volume setup (S802).

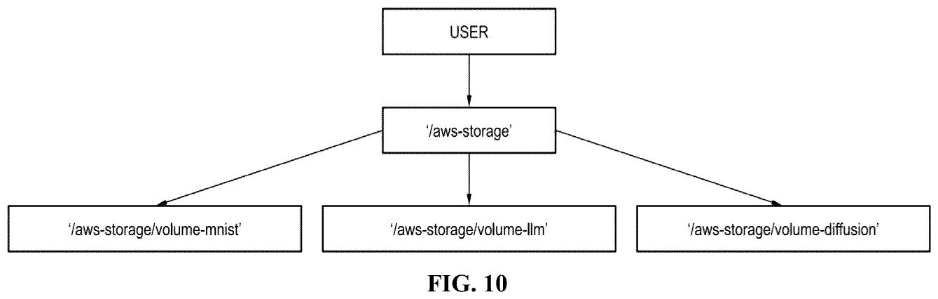

That is, the agent may provide volume management of a one-to-many relationship based on the logical storage. The agent builds an architecture capable of easily generating a plurality of volumes during interworking with one storage so as to enable management and reuse of data at detailed file unit. FIG. 10 shows an example of one-to-many volume management and shows an example in which the user configures three volumes “/aws-storage/volume-mnist”, “/aws-storage/volume-llm”, and “/aws-storage/volume-diffusion” in association with one storage “/aws-storage”. An example in which three volumes are generated in synchronization with the same target storage “/aws-storage” is illustrated in FIG. 10, but the present disclosure is not limited thereto. For example, because the logical storage includes a plurality of different target storage, it is possible to configure volumes for respective different target storage, respectively.

In response to a machine learning task request from the user, the machine learning operations platform may verify the machine learning task request and may generate a job specification (S803).

Afterwards, based on a request for the logical storage included in the job specification, the machine learning operations platform may mount or import volume data of the target storage to perform a machine learning task (S804).

The machine learning operations platform may perform the machine learning task by using the volume data (in a mount case, volume data of the target storage; in an import case, imported local volume data) allocated at step S804 (S805).

Unlike the case where the volume data are allocated in a mount type at step S804, in the case where the volume data are allocated in an import type, when the machine learning task for the imported volume data is completed, the machine learning operations platform may again export a result of the corresponding machine learning task to the target storage (S806).

The description given with reference to FIG. 8 is given as the subject of performing step S801 or step 802 is the agent. However, this includes the case where step S801 or step 802 is performed through the interworking with the machine learning operations platform under leading control of the agent, as well as the case where the agent solely performs step S801 or the step S802.

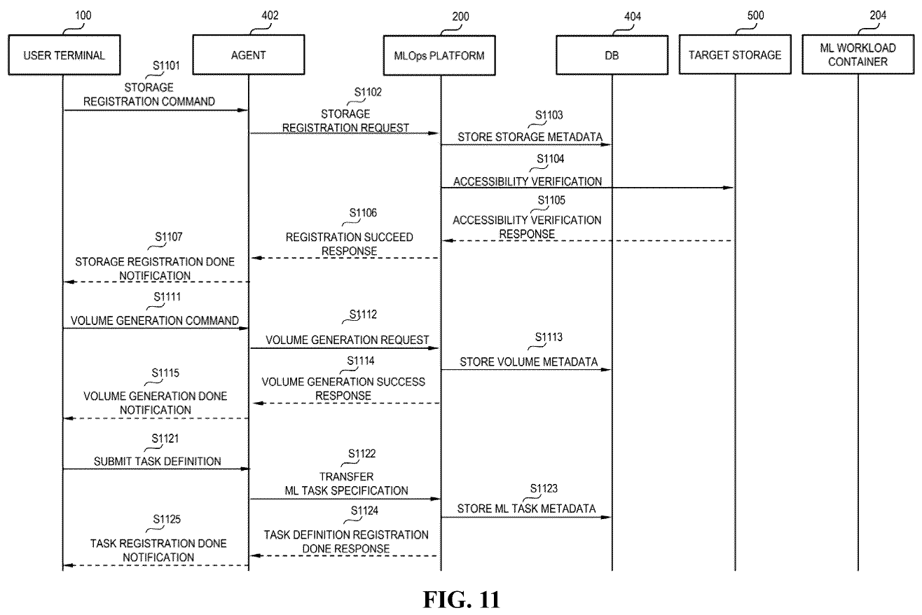

FIG. 11 is a sequence diagram illustrating a storage registration and volume generation process for heterogeneous storage integrated management, according to an embodiment of the present disclosure.

A logical storage registration process S1101 to S1107, a volume generation process S1111 to S1115, and a job specification definition process S1121 to S1125 are illustrated in FIG. 11.

The logical storage registration process S1101 to S1107 will be described with reference to FIG. 11.

The user terminal 100 may transmit a storage registration command to an agent 402 (S1101). The agent 402 may generate a storage registration request in response to the storage registration command from the user terminal 100 (S1102). Herein, the storage registration request may include storage information and authentication information about a plurality of storages, that is, heterogeneous storage.

The machine learning operations platform 200 may store storage metadata and storage authentication information included in the storage registration request in a database 404 (S1103). That is, to access a target storage, there is a need to an authentication key, a token, and an access authority settings depending on a type of the corresponding target storage. For this reason, when the user generates the logical storage, the user may provide authentication information about a plurality of target storage together and may register and store the authentication information in the database 404 of the system. As an example, the authentication information may be encrypted and stored in metadata storage such as VESSL Database and may be automatically used in response to an API call at a necessary time.

The machine learning operations platform 200 may perform accessibility verification on the storage registration request (S1104) and may check a response thereto (S1105). The accessibility verification which is verification for an access and an authority associated with the target storage inputted by the user may be performed by checking the authentication information inputted by the user.

When the access to all the target storage is verified, the machine learning operations platform 200 may provide a registration success response to the agent 402 (S1106).

The agent 402 may completely set up the target storage as one logical storage and may provide storage registration done notification to the user terminal 100 (S1107). That is, the agent 402 may set storage interworking by generating the storage registration information about the user based on a result of the accessibility verification. Herein, the storage registration information may include storage meta data and authentication information about a plurality of storages, that is, heterogeneous storage.

The logical storage thus generated which is a high-level concept for integrally managing various external storage, that is, target storage (e.g., AWS S3, GCS, NFS, and a local disk) with a single interface and may support CRUD APIs for storage interworking. The CRUD API which is an application programming interface (API) supporting create, read, update, and delete tasks on storage may provide an upload (create/upload) function to store a local file in the storage backend, a download (read/download) function to locally import a file stored in storage, a delete function to delete a file present in storage, and a list (list inquiry) function to query a list of files in a specific path in storage, with respect to the logical storage.

The agent 402 may provide the user with the integrated interface providing the above functions associated with the logical storage, and through the integrated interface, the user may perform file-based CRUD computation on various backend storage by using a consistent interface.

After the creation and registration of the logical storage, the agent 402 may manage a type, an access path, and authentication information of the target storage associated with the logical storage as metadata. The metadata may be stored in the database 404. Storage metadata and storage authentication information about the logical storage, metadata about a volume generation request to be described later, and metadata about a machine learning task definition specification may also be stored in the database 404.

When the logical storage is generated as described above, the user may perform volume generation on the logical storage, and the volume generation process S1111 to S1115 will be described.

The user terminal 100 may transmit the volume generation command to the agent 402 (S1111). The agent 402 may request volume generation in response to the volume generation command from the user terminal 100 (S1112). Herein, the volume generation request may include logical storage information and volume information.

The machine learning operations platform 200 may record metadata about the volume generation request in the database 404 to perform logical volume setup (S1113).

Afterwards, the machine learning operations platform 200 may provide a volume generation success response to the agent 402 (S1114), and the agent 402 may provide a volume generation done notification to the user (S1115).

Herein, the volume which is a logical unit derived from the storage provides a space for performing learning by the ML workload. For example, the access to the volume is possible through a POSIX file system interface within the ML workload container.

The volume is characterized in terms of one-to-many relationship support, volume-specific metadata management, and file system form provision. The one-to-many relationship support may mean that each of a plurality of volumes created from one storage operates in an independent file system partition. The volume-specific metadata management may mean that a creation time point, a path, an allocation policy, etc. for each volume are recorded at the database 404 as metadata; in this case, a volume may be identified through the metadata, and the access to the corresponding volume may be performed by using the metadata during the import, export, or mount. A volume may be mounted on a local directory within the container, and the file system form provision means that the user accesses volume data by using an existing API (file open, read, write, directory management, etc.) without modification.

As described above, when the logical storage is set up and a volume(s) is completely created, the user may request a machine learning task from the volume or the storage, and the machine learning task request process S1121 to S1125 will be described.

The user terminal 100 may transmit task definition to the agent 402 (S1121).

The agent 402 may receive the task definition from the user terminal 100 and may provide the machine learning operations platform 200 with the ML task specification for generating the machine learning task definition specification based on the task definition (S1122). As an example, the agent 402 may specify a task volume of the logical storage for performing machine learning and may set the ML task specification by setting a method for allocating the corresponding task volume and a path.

The machine learning operations platform 200 may generate the machine learning task definition specification based on the ML task specification. As an example, the machine learning operations platform 200 may generate the machine learning task definition specification including the task volume, the allocation method, and the path in the ML task specification.

The machine learning operations platform 200 may provide a task definition registration done response to the agent 402 (S1124), and the agent 402 may provide a task registration done notification to the user terminal 100 based on the task definition registration done response (S1125).

An example of the task definition process will be described above. The user may designate at least one of an import path, a mount path, and an export path in association with the ML task (YAML setting, CLI command, SDK API call, etc.). For example, the task definition may be performed as follows: after connecting a “/data” directory with a specific volume, import a file of the corresponding volume while driving the container. The machine learning operations platform 200 may generate ML task metadata based on the task definition, so as to be stored in the database 404. The machine learning operations platform 200 may perform storage allocation processing to be described later, such as import, mount, or export, by referring to the ML task metadata and may perform machine learning based on the storage allocation processing. Through the above process, it is possible to access data through a volume in all the ML pipeline processes such as model parameter load, learning data access, and resultant output storage. The definition of the machine learning task specification may refer to the description given with reference to FIGS. 2 to 7.

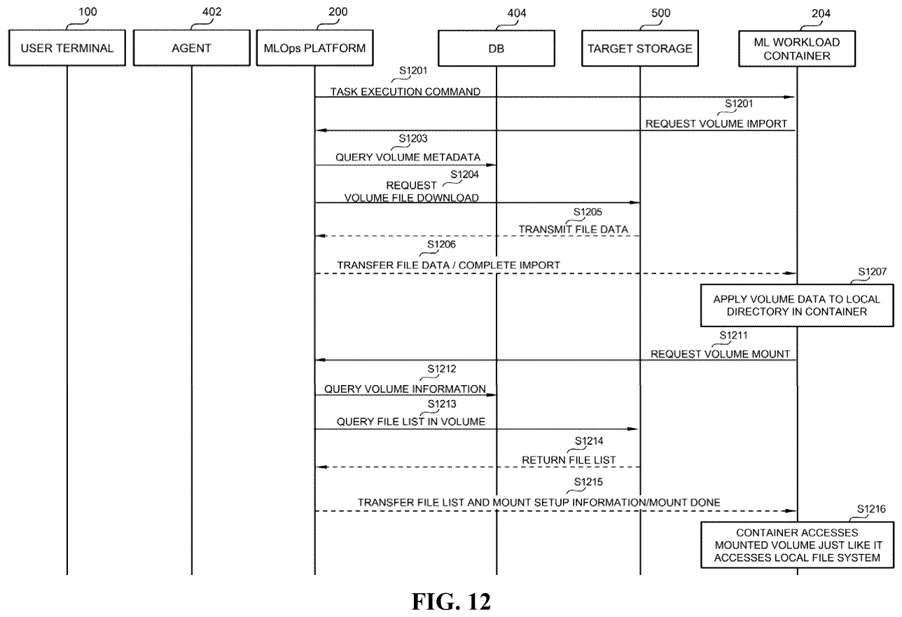

FIG. 12 is a sequence diagram illustrating a volume import process and a volume mount process which are performed based on logical storage when a machine learning task is performed by using integrated logical storage, according to an embodiment of the present disclosure.

Each step of FIG. 12 is associated with a process in which after a machine learning task definition specification is generated in response to the machine learning task request from the user terminal 100 by the agent 402 described with reference to FIG. 11, a volume import or mount is performed depending on the corresponding machine learning task definition specification.

That is, based on the machine learning task definition specification, the machine learning operations platform 200 may check a task volume belonging to the logical storage and may mount or import volume data of the target storage corresponding to the task volume; afterwards, the machine learning operations platform 200 may perform machine learning on the mounted or imported volume data.

An import process S1201 to S1207 and a mount process S1211 to S1216 will be described in detail with reference to FIG. 12.

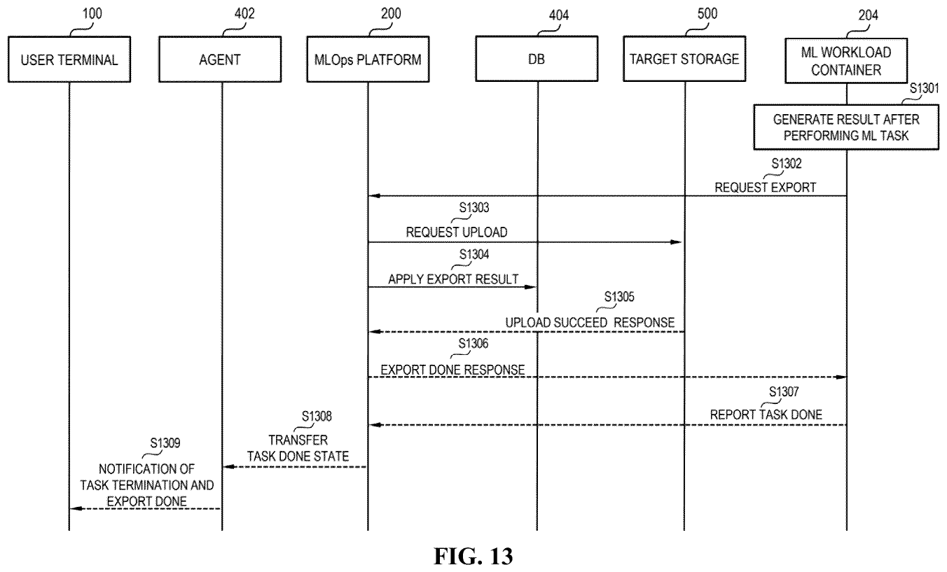

Below, for convenience of description, in FIGS. 12 and 13, the description will be given under the condition that the machine learning operations platform 200 is divided into the platform 200 and the ML workload container 204, but the platform 200 and the ML workload container 204 may be implemented as one component depending on an embodiment.

First, the import process will be described. The machine learning operations platform 200 transfers the machine learning task definition specification to the ML workload container 204 and generates a task execution command (S1201). The ML workload container 204 may check the machine learning task definition specification and provides an import request for a required volume to the machine learning operations platform 200 (S1202).

The machine learning operations platform 200 may check volume metadata about the volume corresponding to the import request from the database 404 (S1203), may access a target storage 500 by using the checked volume metadata to provide a volume file download request (S1204), and may receive corresponding volume file data from the target storage 500 (S1205).

When the volume file is successfully imported from the target storage 500 through the above process, the machine learning operations platform 200 may provide the ML workload container 204 with “import done” including information about the volume file (S1206); and the ML workload container 204 may perform machine learning by applying the imported volume data to a local directory in the container 204 (S1207).

A mount process S1211 to S1216 will be described in detail with reference to FIG. 12.

When the machine learning operations platform 200 transfers the machine learning task definition specification to the ML workload container 204 to generate the task execution command, the ML workload container 204 checks the machine learning task definition specification and provides a mount request for the required volume to the machine learning operations platform 200 (S1211).

The machine learning operations platform 200 may check volume information about the volume corresponding to the mount request from the database 404 (S1212), and the machine learning operations platform 200 may query a file list in the checked volume and may access the target storage 500 to provide a file list request and the mount request (S1213). The machine learning operations platform 200 may receive the file list from the target storage 500 (S1214) and may perform mount setup based on the file list.

The machine learning operations platform 200 may provide the file list and mount setup information to the ML workload container 204 to provide notification that the mount is completed (S1215), and the ML workload container 204 may access the mounted volume like the local system in the container 204 to perform machine learning (S1216).

FIG. 13 is a sequence diagram illustrating a volume export process which is performed based on logical storage when a machine learning task is performed by using integrated logical storage, according to an embodiment of the present disclosure.

After machine learning is completed in the ML workload container 204 through the import process of FIG. 12, an export process in which the corresponding volume data are moved to the target storage, and FIG. 13 describes the export process.

Referring to FIG. 13, when the ML workload container 204 completes the execution of the machine leaning task and generates a result (S1301), the ML workload container 204 may request to export the volume data including the result (S1302).

When the export request is received, the machine learning operations platform 200 may check a target storage on which the import is performed, may submit an upload request for export to the corresponding target storage, and may perform upload based on a response to the upload request (S1303).

When the export is completed, the machine learning operations platform 200 may apply the export result to the database 404 (S1304). Alternatively, the export result may be applied after an upload success response is received from the target storage 500 (S1305).

When the export is completed, the machine learning operations platform 200 may provide an export done response to the ML workload container 204 (S1306); the ML workload container 204 may check the export done response and may finally generate a task done report so as to be provided to the machine learning operations platform 200 (S1307); the machine learning operations platform 200 may transfer a task done state to the agent 402 based on the task done report (S1308), and the agent 402 may notify the user terminal 100 that the task is terminated and the export is completed (S1309).

According to the above description, the volume data of the storage necessary for machine learning may be allocated or utilized while importing, mounting, or exporting the volume of the target storage based on the logical storage.

In an embodiment, the volume-related tasks (e.g., creation, inquiry, mount path setup, and data upload/download) are capable of being defined through an YAML (Yet Another Markup Language) configuration file. This may help facilitate integration into DevOps and MLOps pipelines by increasing the user's readability of which volume is mapped to any path in a container where a machine learning task is actually performed, when defining a machine learning task, and increasing the level of convenience and automation. The user may declare the container mount path through the YAML setting file and may connect the corresponding path with a specific volume.

An example of a configuration using the YAML configuration is as follows.

import: /data: volume://aws-s3-storage/example-volume mount: /model: volume://user-nfs-storage/model-volume export: /output: volume://user-nfs-storage/output-volume

When the user designates mapping as described above, the container 204 loads or mounts data as follows such that the user may use each data storage in the container like local file storage.
Load volume data designated to aws s3 storage to the “/data” path
Enable direct access/management of a model file designated to NFS through the “/model” directory
Store the result After execution in a volume defined in “user-nfs-storage/output-volume” through the “/output” path

In this way, the volume may be easily recognized and allocated based on the logical storage, which simplifies complex problems so as to be provided to the user. Accordingly, the usability of machine learning may be easily improved.

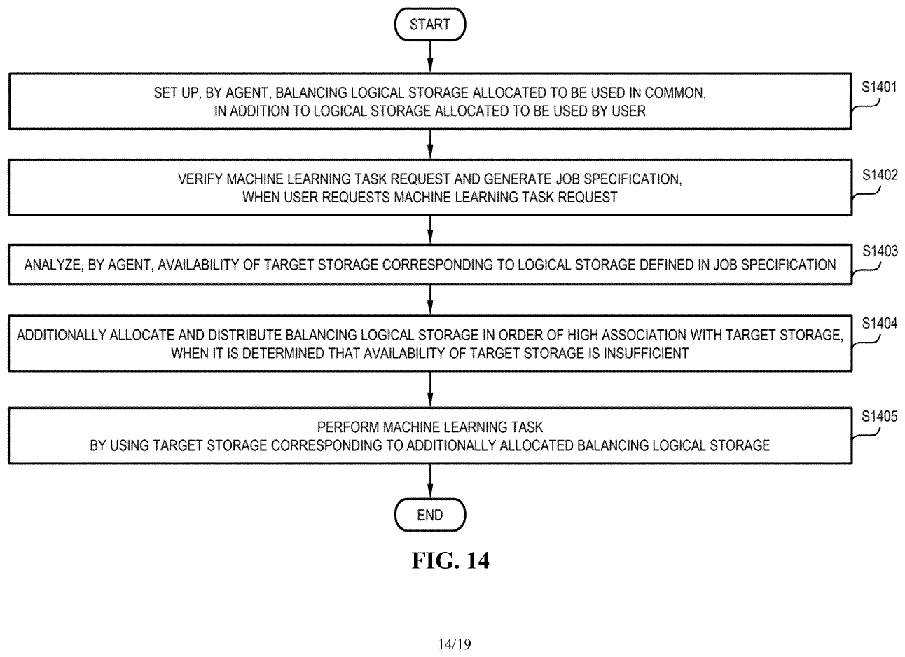

FIG. 14 is a flowchart describing a balancing allocation method in a logical storage management method for heterogeneous storage integrated management in a machine learning environment, according to an embodiment of the present disclosure.

Referring to FIG. 14, the agent 402 may separately set up balancing logical storage allocated to be used in common, in addition to the logical storage allocated to be used by the user (S1401).

That is, the balancing logical storage allocated to be used in common may be set up in addition to the logical storage allocated for each individual. The balancing logical storage may include various target storages allocated to personal logical storage.

When the user requests a machine learning task, the agent 402 may verify the machine learning task request and may generate the job specification (S1402).

The agent 402 may analyze whether a target storage corresponding to logical storage defined in the job specification is available (S1403). That is, the agent 402 may determine whether logical storage of the corresponding individual defined in the job specification is sufficiently available.

When it is determined that availability is insufficient, the agent 402 may additionally allocate and distribute balancing logical storage in the order of high association with the target storage whose availability is insufficient (S1404).

For example, when the user requests the job specification from cloud storage A among the logical storage but availability (e.g., the amount of volume data) of cloud storage A allocated to the user is smaller than the request, the agent 402 may determine that availability is insufficient and may additionally allocate and distribute some volumes of the balancing logical storage to the user. Herein, association is allocated to be higher in the order depending on whether it has same storage type (whether or not of cloud or on-premise). That is, when cloud storage A among the balancing logical storage is sufficient, cloud storage A may be allocated to the user; when cloud storage A is insufficient, another cloud storage B having the same type as cloud storage A may be allocated to the user.

The machine learning operations platform 200 may perform the machine learning task by using target storage corresponding to additionally allocated balancing logical storage (S1405).

The embodiment of FIG. 14 provides the effect of efficiently compensating for the shortage of logical storage, which a plurality of users are able to experience, by providing a small amount of balancing logical storage.

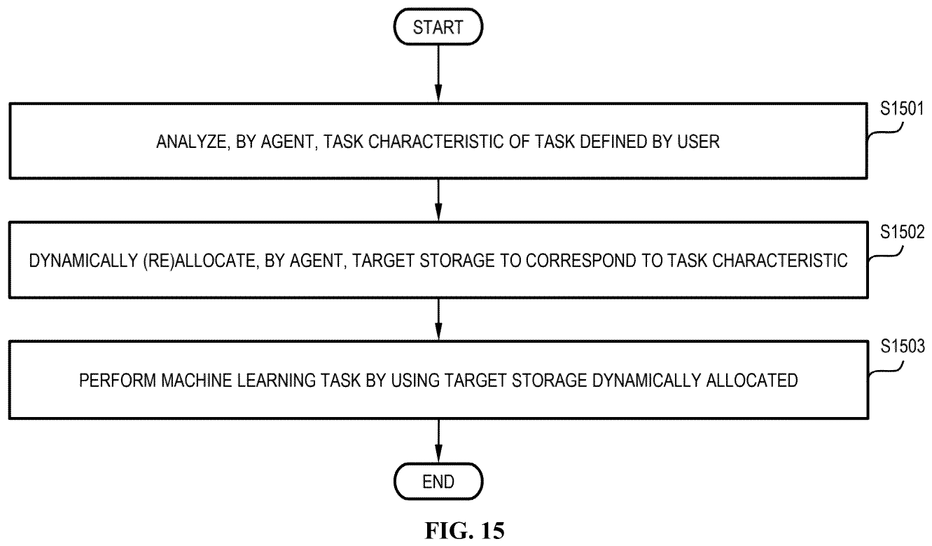

FIG. 15 is a flowchart describing a method of dynamically reallocating workload-specific storage, according to an embodiment of the present disclosure.

The agent 402 may analyze a task characteristic of a task which the user defines (S1501).

The agent 402 may dynamically allocate or reallocate target storage based on the task characteristic (S1502). For example, the agent 402 may have a criterion for allocating storage depending on a characteristic (e.g., model training or data preprocessing) of a task which the user defines and may dynamically allocate or reallocate target storage to correspond to the user-defined task, based on the criterion.

The machine learning operations platform 200 may perform a machine learning task by using the dynamically allocated target storage (S1503).

For example, according to the criterion for allocating storage depending on a task characteristic, data requiring a high-speed access may be moved to non-volatile memory express (NVMe)-based storage, and long-term storage data may be moved to low-cost HDD-based storage.

Through the above embodiment, a result of analyzing a dataset size and computational complexity is capable of being utilized for connection with an appropriate storage resource in real time. Accordingly, the effects such as workload performance optimization and cost efficiency may be secured.

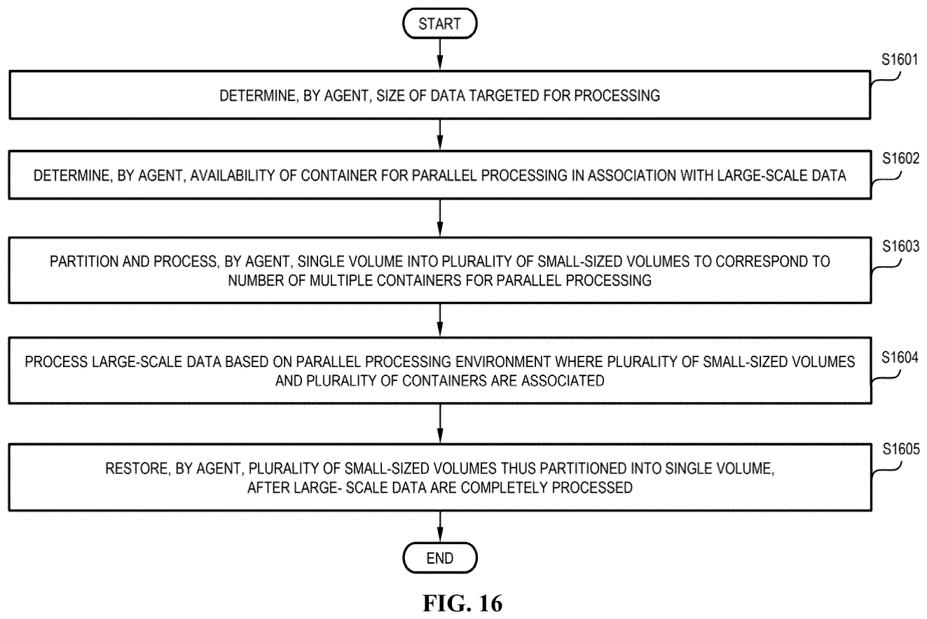

FIG. 16 is a flowchart describing a volume automatic-partition and merging providing method, according to an embodiment of the present disclosure.

The agent 402 may determine the size of data targeted for processing (S1601).

The agent 402 may determine that a container 204 for parallel processing on a large-scale data is available (S1602).

The agent 402 may partition a single volume to a plurality of small-sized volumes into correspond to the number of multiple containers for parallel processing (S1603).

The machine learning operations platform 200 may build a parallel processing environment by associating the plurality of small-sized volumes thus automatically partitioned with the plurality of containers and may process large-scale data based on the parallel processing environment (S1604).

After the large-scale data are completely processed, the agent 402 may restore the plurality of small-sized volumes thus partitioned to the single volume of an original state (S1605).

Through the above embodiment, as a large file is partitioned into small units, the large file may be simultaneously processed in several containers. This embodiment provides the effect of efficiently using a storage space while improving a speed at which large-scale data are processed.

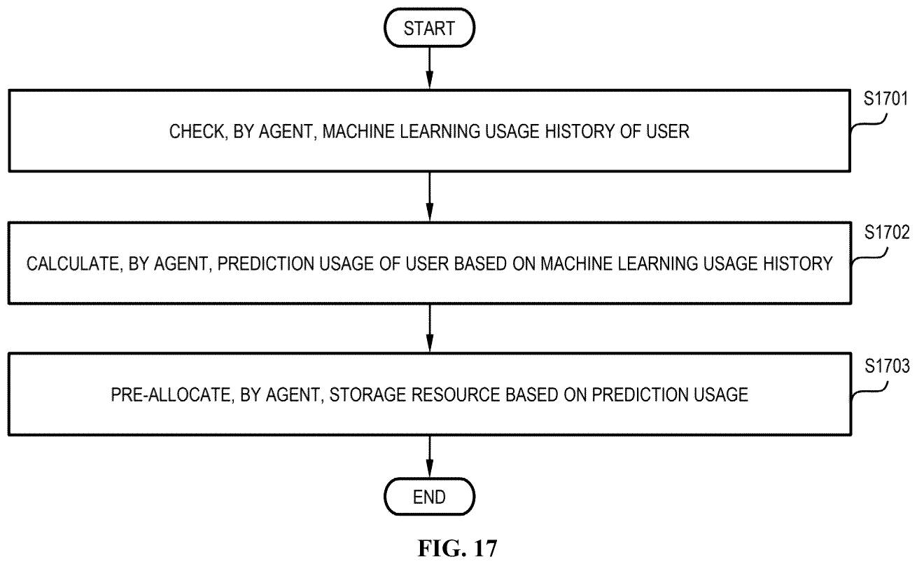

FIG. 17 is a flowchart describing a storage availability prediction and pre-allocation method, according to an embodiment of the present disclosure.

The agent 402 may check a machine learning usage history of the user (S1701).

The agent 402 may calculate a predicted usage of the user based on the machine learning usage history (S1702).

The agent 402 may pre-allocate a storage resource based on the predicted usage (S1703).

This embodiment relates to an embodiment in which an available storage resource is predicted and pre-allocated before the machine learning task request of the user is received. Herein, when calculating the predicted usage of the user, a prediction model which operates based on a previous usage pattern of the user, a task type, a data size, etc. may be used.

Through the above embodiment, appropriate storage may be reserved based on the workload predicted a day ago. This embodiment provides the effect of reducing a task waiting time and enabling the user to perform a task at a desired time.

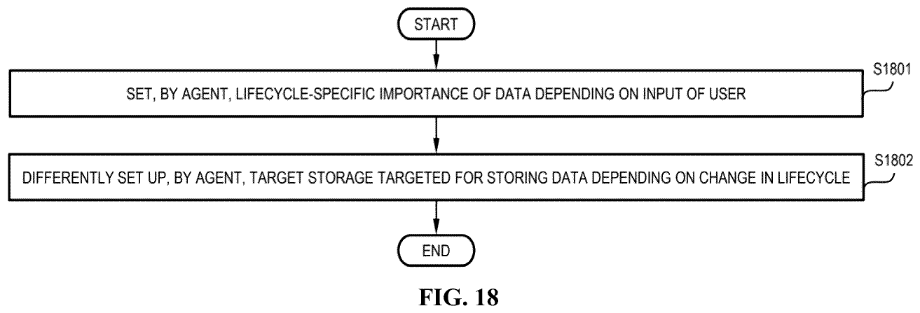

FIG. 18 is a flowchart describing a storage-based data lifecycle management method according to an embodiment of the present disclosure.

The agent 402 may set the importance for each lifecycle of data depending on an input of the user (S1801).

The agent 402 may differently set up target storage for storing data depending on a change in the lifecycle (S1802).

The above embodiment is an embodiment associated with a method of managing the entire lifecycle from a data-generated time to storage and deletion, and the user may set a storage policy depending on the importance of data. For example, the target storage may be set up differently in the form of high-speed storage, low-speed storage, or archiving depending on the importance.

Through the above embodiment, temporary data used for model training may be automatically deleted after a given time period. The embodiment provides the effect of optimizing data utilization while lowering data storage costs.

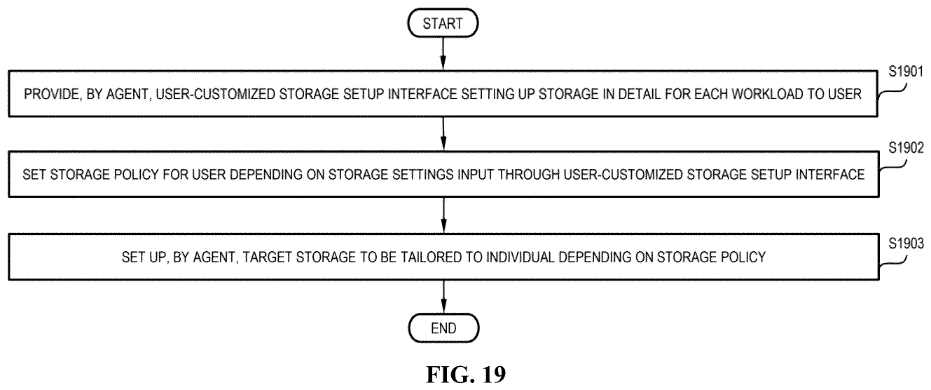

FIG. 19 is a flowchart describing a method of providing a user-customized storage policy according to an embodiment of the present disclosure.

The agent 402 may provide a user-customized storage setup interface for setting up storage in detail for each workload to the user (S1901).

The agent 402 may set a storage policy for the user depending on storage settings input through the user-customized storage setup interface (S1902). The policy may include a read/write priority, a data encryption level, an authority to access data, etc.

The agent 402 may set up target storage to be tailored to an individual depending on the storage policy (S1903).

Through the above embodiment, important data may be utilized to provide high-speed encryption and limited access policies. The embodiment provides the effect of providing a storage environment tailored to user requirements.

The machine learning operations system according to an embodiment may include a computer program which is stored in a non-transitory computer-readable recording medium coupled to a computer or a computing device, which is hardware, and performs the above steps.

The machine learning operations system according to an embodiment may be implemented with a computing device including at least one processor which executes instructions of programs loaded to a memory. A program including the instructions described to execute step S600 to step S610 of FIG. 6 described above may be loaded to the memory of the computing device.

The foregoing devices may be implemented by a hardware component, a software component, and/or a combination of a hardware component and a software component. For example, the devices and the components described in the embodiments may be implemented by using one or more general-purpose computers or special-purpose computers, like a processor, a controller, an arithmetic logic unit (ALU), a digital signal processor, a microcomputer, a field programmable gate array (FPGA), a programmable logic unit (PLU), a microprocessor, or any device which may execute instructions and may respond thereto. A processing unit may execute an operating system (OS) or one or more software applications running on the operating system. Also, the processing unit may access, store, manipulate, process, and generate data in response to the execution of software. For convenience of understanding, the description is given as a single processing unit, but it will be understood by one skilled in the art that the processing unit may include a plurality of processing elements and/or a plurality of types of processing elements. For example, the processing device may include a plurality of processors or may include one processor and one controller. Also, any other processing configuration such as a parallel processor is possible.

Software may include a computer program, a code, an instruction, or one or more combinations thereof and may constitute a processing device to operate in a desired manner or may control the processing device independently or collectively. Software and/or data may be permanently or temporarily embodied in any type of a machine, a component, physical equipment, virtual equipment, a computer storage medium, a computer device or in a transmitted signal wave, so as to be interpreted by the processing unit or to provide instructions or data to the processing unit. Software may be distributed on computer systems connected over a network so as to be stored therein or executed thereon. Software and data may be recorded in one or more computer-readable storage media.

The method according to the embodiment may be recorded in a computer-readable medium including a program instruction executable through various computer devices. The computer-readable medium may also include a program instruction, a data file, a data structure, or a combination thereof. The program instruction recorded in the medium may be designed and configured specially for the embodiment or may be known and available to one skilled in computer software. The computer-readable storage medium may include, for example, a hardware device, which is specially configured to store and execute a program instruction, such as a magnetic medium (e.g., a hard disk drive, a floppy disk or a magnetic tape), an optical medium (e.g., CD-ROM or DVD), a magneto-optical medium (e.g., a floptical disk), a read only memory (ROM), a random access memory (RAM), or a flash memory. As an example, the program instruction includes not only a machine language code created by a compiler but also a high-level language code capable of being executed by a computer by using an interpreter or the like. The hardware device may be configured to act as one or more software modules to perform the operation of the embodiment, and vice versa.

According to embodiments, heterogeneous storage resources may be managed with a single interface across various environments such as cloud and on-premise, and thus, effects of managing the storage in one integrated environment and providing storage management effects to the user more conveniently may be provided.

According to embodiments, based on the availability analysis associated with the status of user logical storage allocated to an individual, a public balancing logical storage having high environmental similarity the same as that of the target storage having insufficient availability may be allocated and used, and thus, an effect of balancing the lack of availability for storage of multiple users with only small public storage may be provided.

According to embodiments, it may be possible to flexibly establish a cloud-level MLOps platform even in an on-premise environment for data security and regulatory compliance, and thus, container-based ML/AI project productivity and quality may be improved through efficient allocation and monitoring of a special hardware resource such as a GPU.

According to embodiments, security may be enhanced through mutual TLS authentication and an auto-generated one-time token, and network security policy constraints may be overcome by using only the outbound connection.

According to embodiments, machine learning costs may be optimized through a real-time resource monitoring and dynamic allocation system in a container environment.

According to embodiments, by utilizing a cluster agent and a sidecar container, it may be possible to effectively collect various indicators and logs and to transmit the collected indicators and logs to a user, and thus, performance or indicator monitoring and maintenance of a machine learning model may become easier.

Effects according to the present disclosure are not limited to the above effects, and effects not mentioned herein may be clearly understood from the specification and the accompanying drawings by one skilled in the art to which the present disclosure pertains.

Although the present disclosure has been described above with reference to the limited exemplary embodiments and drawings, various modifications and variations can be made from the above description by those of ordinary skill in the art. For example, even when the described techniques are performed in an order different from the method described above, and/or even when components of the described system, structure, device, circuit, and the like are coupled or combined in a form different from the way described above or replaced or substituted with other components or equivalents, an appropriate result can be achieved.

Therefore, other implementations, other embodiments, and equivalents to the claims fall within the scope of the following claims.

What is claimed is:

1. A logical storage management method for heterogeneous storage integrated management in a machine learning environment, which is performed by a machine learning operations system including an agent and a machine learning operations platform, the method comprising:
creating, by the agent, logical storage for a user, which is capable of being managed by integrating a plurality of heterogeneous storage, in response to a storage registration command from the user;
setting up, by the agent, a logical volume by generating the logical volume and volume metadata for the logical storage based on the logical storage in response to a volume generation command from the user; and
performing, by the machine learning operations platform, a machine learning task by mounting or importing volume data of target storage corresponding to a volume of the logical storage in response to a machine learning task request from the user.

2. The method of claim 1, further comprising:
when the machine learning task on the imported volume data is completed, exporting the corresponding volume data to the target storage.

3. The method of claim 1, wherein the creating of the logical storage for the user includes:
generating, by the agent, a storage registration request in response to the storage registration command from the user, wherein the storage registration request includes storage information and authentication information about the plurality of heterogeneous storage;
performing, by the machine learning operations platform, accessibility verification on the storage registration request; and
setting storage interworking by generating storage registration information about the user based on a result of the accessibility verification, wherein the storage registration information includes storage metadata and authentication information about the plurality of heterogeneous storage.

4. The method of claim 2, wherein the setting up of the logical volume includes:
generating, by the agent, a volume generation request in response to the volume generation command from the user, wherein the volume generation request includes logical storage information and volume information; and
setting up, by the machine learning operations platform, the logical volume by recording metadata about the volume generation request in a database.

5. The method of claim 3, wherein the performing of the machine learning task by mounting or importing the volume data of the target storage corresponding to the volume of the logical storage includes:
generating, by the agent, a machine learning task definition specification in response to the machine learning task request from the user;
checking, by the machine learning operations platform, a task volume belonging to the logical storage depending on the machine learning task definition specification and mounting or importing volume data of target storage corresponding to the task volume; and
performing, by the machine learning operations platform, machine learning on the mounted or imported volume data.

6. The method of claim 5, wherein the generating of the machine learning task definition specification in response to the machine learning task request from the user includes:
specifying, by the agent, the task volume in the logical storage from the machine learning task request from the user;
setting, by the agent, a path and an allocation method for allocating the task volume; and
generating, by the machine learning operations platform, the machine learning task definition specification including the task volume, the allocation method, and the path.

7. The method of claim 6, wherein the machine learning operations system includes a database configured to store:
the storage metadata and storage authentication information;
metadata associated with a volume generation request;
metadata associated with the machine learning task definition specification.

8. A machine learning operations system comprising:
a machine learning operations platform configured to perform machine learning depending on a job specification associated with a machine learning task request, when the machine learning task request is received from a user; and
a logical storage agent configured to integrate and manage a plurality of heterogeneous storage,
wherein the logical storage agent is configured to:
create logical storage for the user, which is capable of being managed by integrating the plurality of heterogeneous storage, in response to a storage registration command from the user; and
set up a logical volume by generating the logical volume and volume metadata for the logical storage based on the logical storage in response to a volume generation command from the user,
wherein the machine learning operations platform is configured to:
perform a machine learning task by mounting or importing volume data of target storage corresponding to a volume of the logical storage in response to the machine learning task request from the user.

9. A non-transitory computer-readable recording medium including instructions causing a computer to execute the method of claim 1.
